(19) United States
(12) Patent Application Publication
(10) Pub. No.: US 2014/0035426 A1
(43) Pub. Date: Feb. 6, 2014

(54) STATOR INCLUDING CONDUCTORS PROVIDED WITH A CERAMIC COVERING

(71) Applicants: Cameron Perry, Albion, IN (US); Colin Hamer, Noblesville, IN (US)

(72) Inventors: Cameron Perry, Albion, IN (US); Colin Hamer, Noblesville, IN (US)

(73) Assignee: REMY TECHNOLOGIES, L.L.C., Pendleton, IN (US)

(21) Appl. No.: 13/565,355

(22) Filed: Aug. 2, 2012

(51) Int. Cl. H02K 3/30; H02K 15/06; H02K 15/12; H02K 15/04

(52) U.S. Cl. 310/208; 29/596

(57) ABSTRACT

A stator core includes a plurality of slot segments, a plurality of stator winding conductors arranged in select ones of the plurality of slot segments, and a ceramic covering provided on one or more of the plurality of stator winding conductors. The ceramic covering includes an adhesive bonded to the one of the plurality of stator winding conductors to provide insulation for the one or more stator winding conductors.

### BACKGROUND OF THE INVENTION

Exemplary embodiments pertain to the art of electric machines and, more particularly, to a stator including conductors provided with ceramic covering.

Electric machines include stators that are wound with one or more conductors. The one or more conductors form a stator winding that is designed to impart or receive an electro-motive force from rotor windings to either power the electric machine in the case of an electric motor, or pass an electrical current to an external load in the case of a generator. Stators often include multiple stator windings that are joined to establish a desired connection such as a delta connection or a wye connection.

In such cases, windings are joined by jumpers and/or cross-overs that provide desired electrical interconnections. The number of jumpers can vary greatly and often times are required to include multiple bends in order to establish the desired interconnections and to nest with other jumpers without appreciably adding to an overall size of the stator. In addition to the jumpers, stators include phase leads that electrically connect each stator winding to an appropriate electrical phase on an external device, and a neutral bar that provides a neutral connection to the stator. The jumpers, phase leads, and neutral bar are generally provided with an electrical insulation for protection.

### BRIEF DESCRIPTION OF THE INVENTION

Disclosed is a stator including a stator core having a plurality of slot segments, a plurality of stator winding conductors arranged in select ones of the plurality of slot segments, and a ceramic covering provided on one or more of the plurality of stator winding conductors. The ceramic covering includes an adhesive bonded to the one of the plurality of stator conductors to provide insulation for the one or more stator winding conductors.

Also disclosed is an electric machine including a housing, a rotor rotatably mounted within the housing, and a stator mounted to the housing and extending about, at least in part, the rotor, the stator. The stator includes a plurality of slot segments, a plurality of stator winding conductors arranged in select ones of the plurality of slot segments, and a ceramic covering provided on one or more of the plurality of stator winding conductors. The ceramic covering includes an adhesive bonded to the one of the plurality of stator conductors to provide insulation for the one or more stator winding conductors.

Further disclosed is a method of forming a stator for an electric machine. The method includes forming a conductor into a stator winding, and joining a ceramic covering to an outer surface of the conductor.

### BRIEF DESCRIPTION OF THE DRAWINGS

The following descriptions should not be considered limiting in any way. With reference to the accompanying drawings, like elements are numbered alike:

FIG. 1 depicts a cross-sectional side view of an electric machine including a stator having conductors provided with a ceramic coating in accordance with an exemplary embodiment;

FIG. 2 depicts a partial perspective view of the stator of FIG. 1;

FIG. 3 depicts a stator conductor prior to application of the ceramic coating;

FIG. 4 depicts the stator conductor of FIG. 3 following application of the ceramic coating; and

FIG. 5 is a partial cross-sectional view of a ceramic coating in accordance with an exemplary embodiment.

### DETAILED DESCRIPTION OF THE INVENTION

A detailed description of one or more embodiments of the disclosed apparatus and method are presented herein by way of exemplification and not limitation with reference to the Figures.

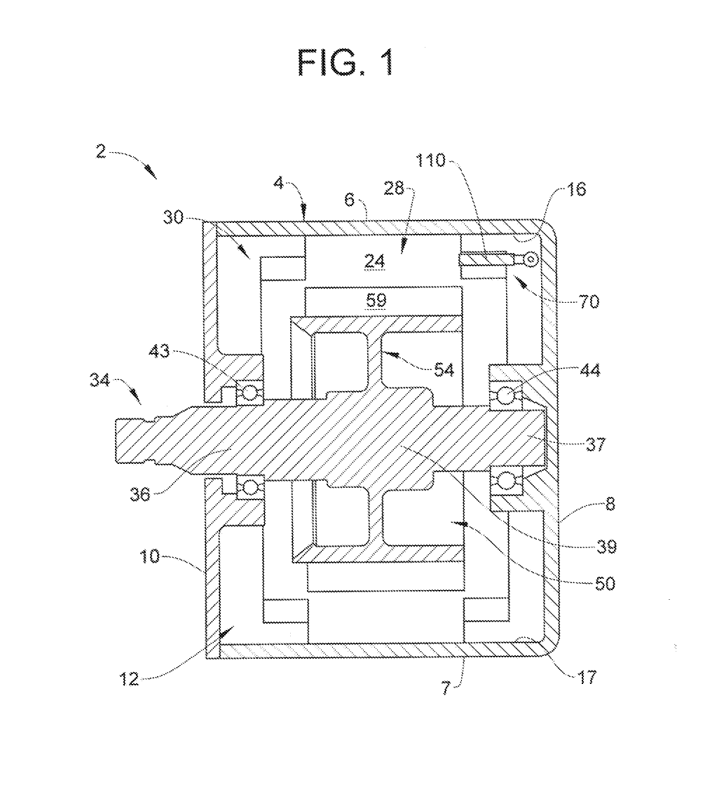

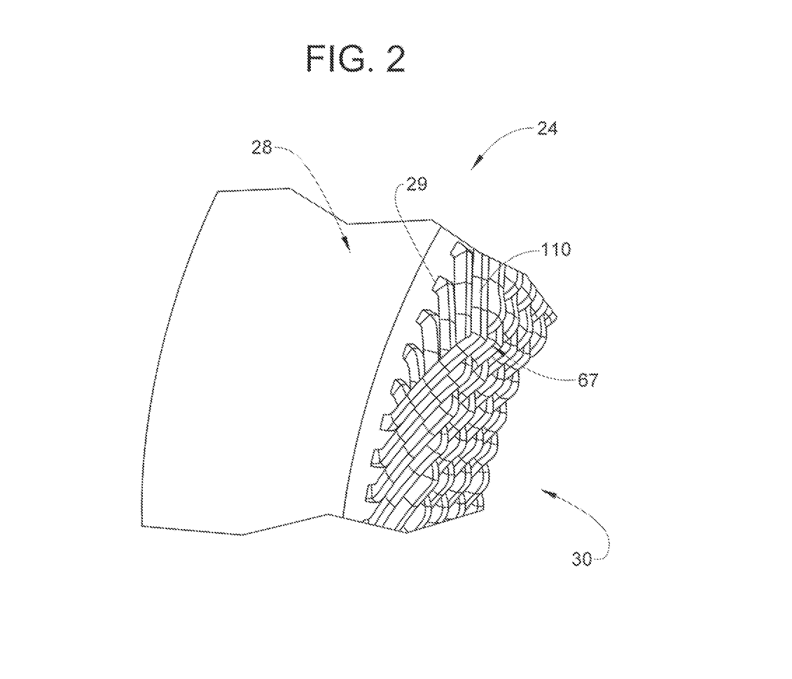

An electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be constructed to include a single side wall having a continuous inner surface. Electric machine 2 is further shown to include a stator 24 arranged at inner surfaces 16 and 17 of first and second side walls 6 and 7. Stator 24 includes a stator core 28 having a plurality of slot segments 29 (FIG. 2) which, as will be discussed more fully below, are provided with a plurality of stator windings 30.

Electric machine 2 is also shown to include a shaft 34 rotatably supported within housing 4. Shaft 34 includes a first end 36 that extends to a second end 37 through an intermediate portion 39. First end 36 is rotatably supported relative to second end wall 10 through a first bearing 43 and second end 37 is rotatably supported relative to first end wall 8 through a second bearing 44. Shaft 34 supports a rotor assembly 50 that is rotatably mounted within housing 4. Rotor assembly 50 includes a rotor hub 54 that is fixed relative to intermediate portion 39 of shaft 34, and a rotor lamination 59 that is configured to rotate relative to stator 24.

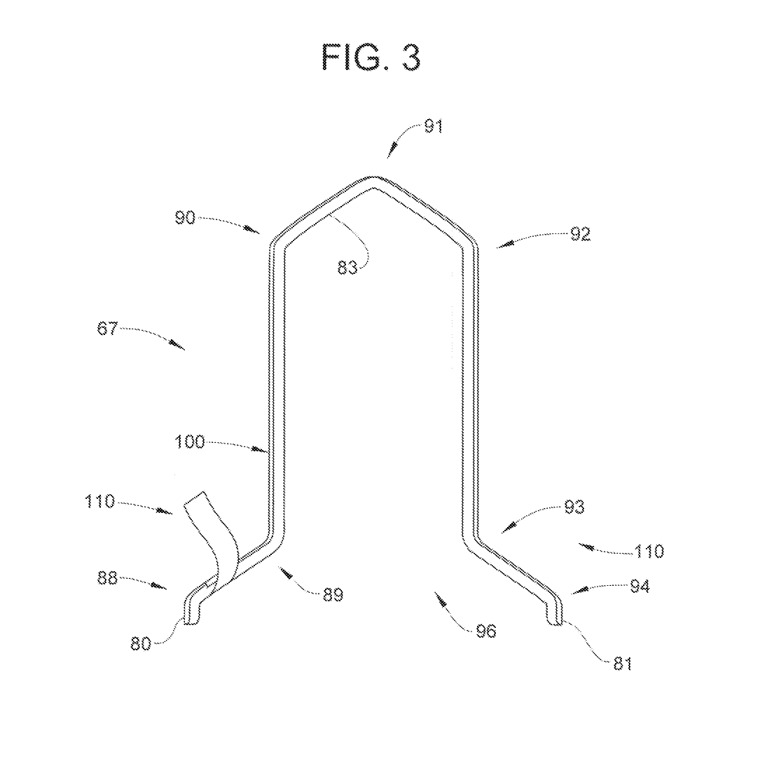

As shown in FIG. 2, stator windings 30 are formed from a plurality of stator winding conductors, one of which is indicated at 67. Stator winding conductors 67 are arranged in select ones of slot segments 29 and selectively connected to establish a desired electrical configuration for stator 24. Stator windings 30 also include one or more terminals (not shown) that provide an electrical connection with stator windings 30. Stator windings 30 further include jumper conductors and one or more common conductors (also not shown) that establish the desired electrical connection for stator 24. As shown in FIG. 3, stator winding conductor 67 includes a first end 80 that extends to a second end 81 through an intermediate portion 83. Intermediate portion 83 includes a number of bends 88-94 that establish a hairpin shape 96 having an outer surface 100.

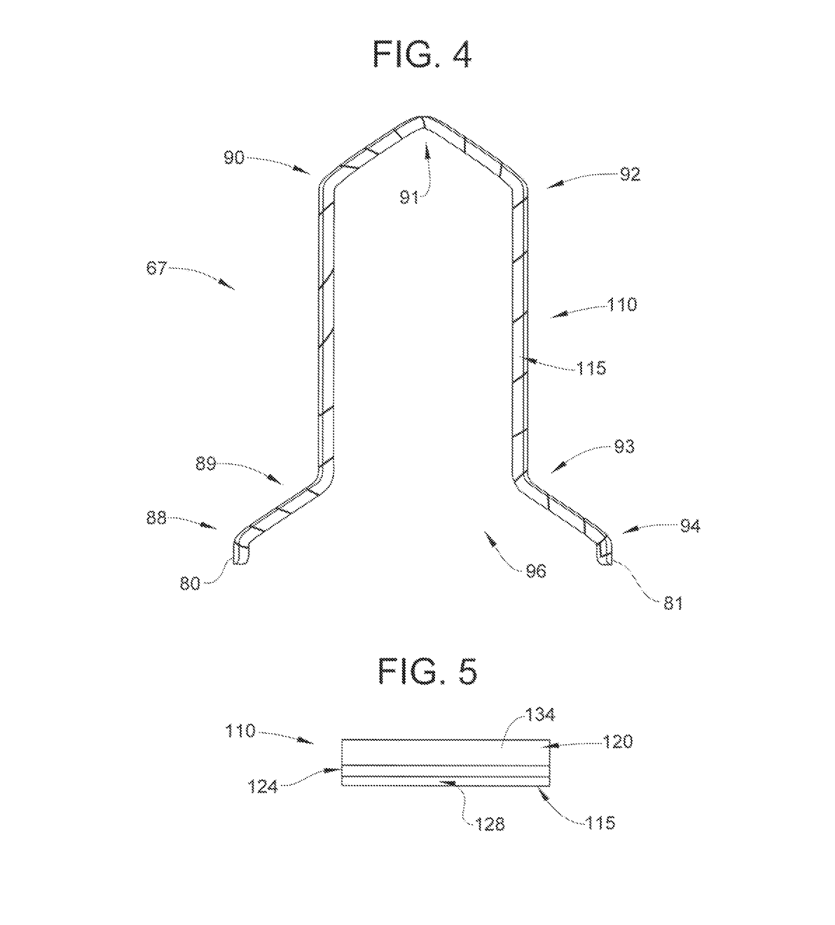

In accordance with an exemplary embodiment, stator winding conductor 67 is wrapped with a ceramic covering 110. Ceramic covering 110 extends from adjacent first end 80 and covers intermediate portion 83 with overlapping wraps that extend to second end 81 as shown in FIG. 4. Ceramic covering 110 provides electrical insulation as well as serve as a thermal and/or protective barrier for stator winding conductor 67. Once wrapped, stator winding conductor 67 is inserted into a desired pair of slot segments 29 in stator core 28 and coupled to other stator winding conductors to form stator winding 30.

In accordance with one aspect of an exemplary embodiment, ceramic covering 110 takes the form of a ceramic tape 115. Ceramic tape 115 includes a ceramic layer 120 an intermediate or flexible layer 124 and an adhesive layer or backing 128. Adhesive backing 128 provides a bond between ceramic tape 115 and outer surface 100. Flexible layer 124 enhances bending of ceramic tape 115 about stator winding conductor 67. Ceramic layer 120 provides electrical insulation as well as heat and/or abrasion resistance for stator winding conductor 67. Ceramic layer may include one or more of beryllium oxide, boron nitride, and alumina. Of course, other ceramic materials may also be employed.

In accordance with another aspect of an exemplary embodiment, ceramic layer 115 is formed from a B-stage ceramic material 134. A B-stage ceramic material is a material in which a limited hardening reaction has been allowed to take place. The reaction is arrested while the ceramic material remains flexible and soluble. The B-stage ceramic material allows for subsequent hardening upon exposure to a hardening input such as heat or light of a particular wavelength. When using B-stage material 134, ceramic tape 115 is subjected to a hardening input after being wrapped about stator winding conductor 67. The hardening input may be applied before installation into stator core 28 or after all stator winding conductors are installed. The hardening input may take the form of applied heat. The applied heat may result from operation of electric machine 2.

At this point it should be understood that the exemplary embodiments provide a ceramic coating for stator winding conductors that serves as electrical insulation as well as provides a thermal and abrasion resistance properties. The ceramic coating may be applied in the form of a tape that is wrapped around the stator winding conductor. The ceramic tape may include a ceramic layer including B-stage ceramic material that is hardened after application. It should also be understood, that the ceramic coating may be applied to all stator winding conductors or to select ones of the stator winding conductors. Further it should be understood that the ceramic coating may be applied prior to forming the stator winding conductor into a desired shape or after the stator winding conductor is formed.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A stator comprising:
a stator core including a plurality of slot segments;
a plurality of stator winding conductors arranged in select ones of the plurality of slot segments; and
a ceramic covering provided on one or more of the plurality of stator winding conductors, the ceramic covering including an adhesive bonded to the one of the plurality of stator conductors to provide insulation for the one or more stator winding conductors.

2. The stator according to claim 1, wherein the ceramic covering comprises a ceramic tape including a ceramic layer.

3. The stator according to claim 2, wherein the ceramic tape includes a flexible layer bonded to the ceramic layer.

4. The stator according to claim 3, wherein the adhesive comprises an adhesive backing provided on the flexible layer.

5. The stator according to claim 1, wherein the ceramic covering comprises a B-stage ceramic material.

6. The stator according to claim 1, wherein the ceramic covering comprises one of beryllium oxide, boron nitride, and alumina.

7. An electric machine comprising:
a housing;
a rotor rotatably mounted within the housing; and
a stator mounted to the housing and extending about, at least in part, the rotor, the stator comprising:
a stator core including a plurality of slot segments;
a plurality of stator winding conductors arranged in select ones of the plurality of slot segments; and
a ceramic covering provided on one or more of the plurality of stator winding conductors, the ceramic covering including an adhesive bonded to the one of the plurality of stator conductors to provide insulation for the one or more stator winding conductors.

8. The electric machine according to claim 7, wherein the ceramic covering comprises a ceramic tape including a ceramic layer.

9. The electric machine according to claim 8, wherein the ceramic tape includes a flexible layer bonded to the ceramic layer.

10. The electric machine according to claim 9, wherein the adhesive comprises an adhesive backing provided on the flexible layer.

11. The electric machine according to claim 7, wherein the ceramic covering comprises a B-stage ceramic material.

12. The electric machine according to claim 7, wherein the ceramic covering comprises one of beryllium oxide, boron nitride, and alumina.

13. A method of forming a stator for an electric machine, the method comprising:
forming a conductor into a stator winding; and
joining a ceramic covering to an outer surface of the conductor.

14. The method of claim 13, wherein joining the ceramic covering to the outer surface of the conductor comprises providing an adhesive bond between the ceramic covering and the outer surface.

15. The method of claim 13, further comprising: curing the ceramic covering to harden a ceramic layer of the ceramic covering.

16. The method of claim 15, wherein curing the ceramic covering includes heating the ceramic covering.

17. The method of claim 16, wherein heating the ceramic covering includes operating an electric machine comprising the stator.

18. The method of claim 13, further comprising: mounting the conductor in a stator core.

19. The method of claim 13, wherein joining a ceramic covering to the outer surface comprises wrapping a ceramic tape around the conductor.

20. The method of claim 19, wherein wrapping the ceramic tape around the conductor comprises wrapping a ceramic tape including a ceramic layer, a flexible layer and an adhesive layer around the conductor.
